(19) United States
(12) Patent Application Publication
(10) Pub. No.: US 2022/0405861 A1
(43) Pub. Date: Dec. 22, 2022

(54) COMMUNICATION ASSISTANCE SERVER, COMMUNICATION ASSISTANCE SYSTEM, COMMUNICATION ASSISTANCE METHOD, AND COMMUNICATION ASSISTANCE PROGRAM

(71) Applicant: Aill Inc., Tokyo (JP)

(72) Inventor: China TOYOSHIMA, Tokyo (JP)

(73) Assignee: Aill Inc., Tokyo (JP)

(21) Appl. No.: 17/779,335

(22) PCT Filed: Nov. 24, 2020
(86) PCT No.: PCT/JP2020/043701

§ 371 Date: May 24, 2022

(30) Foreign Application Priority Data
Nov. 25, 2019 (JP) 2019-212721

(51) Int. Cl. G06Q 50/00

(52) U.S. Cl. CPC G06Q 50/01

(57) ABSTRACT

A system includes: a personal information storage unit configured to store personal information on a user; a disclosure condition determination unit configured to determine whether to disclose personal information on a first user stored in the personal information storage unit to a second user based on whether relationship information on a relationship between the first user and the second user satisfies a disclosure condition; and an information disclosure suggestion unit configured to generate suggestion display information for suggesting that the first user disclose the personal information on the first user to the second user, if the disclosure condition determination unit has determined that the relationship information satisfies the disclosure condition.

### TECHNICAL FIELD

The present disclosure relates to a communication support server, communication support system, communication support method, and communication support program that support communications among people via a network.

### BACKGROUND ART

Social networking services (SNSs) are widely used as a communication tool between people via a network. The SNSs often have chat, messenger, and other functions to allow real time communications.

As an index for selecting an actually unacquainted partner for a communication, the personal information on the partner is useful. There may be however a concern to disclose the personal information to an unspecified large number of people. For example, a system is disclosed (see Patent Document 1) which allows a user to set the range of disclosing personal information in each group to set the personal information to be disclosed to other users belonging to the group. There is also a disclosed system capable of controlling personal information to be disclosed in accordance with the relationship (reliability) between users (see Patent Document 2).

### CITATION LIST

### Patent Documents

Patent Document 1: Japanese Unexamined Patent Publication No. 2010-539565
Patent Document 2: Japanese Unexamined Patent Publication No. 2013-210828

### SUMMARY OF THE INVENTION

### Technical Problems

According to Patent Document 1, however, personal information to be disclosed is set for each group. A user may have personal information not to be disclosed to some specific users belonging to the group, or wishes to disclose information other than the information set to be disclosed in the group. In this case, there is a need to create a new group for the specific users, which is troublesome.

Patent Document 2 describes controlling personal information to be disclosed in accordance with the reliability. There may be however personal information to be or not to be disclosed to a specific user regardless of the reliability. For example, assume that a user desires to have a friendship with a specific user who is not yet highly reliable. The user may wish to disclose some personal information to know the sense of values of the specific user. In this case, the user needs to change the range of disclosing the personal information for the specific user each time, which also makes the settings troublesome.

The present disclosure was made to solve such the problem. It is an objective of the present disclosure to provide a communication support server, communication support system, inspected communication support method, and inspected communication support program that suggest the disclosure of undisclosed personal information to another user in accordance with relationship information between users.

### Solution to the Problem

In order to achieve the objective, a communication support server according to the present disclosure includes: a personal information storage unit configured to store personal information on a user; a disclosure condition determination unit configured to determine whether to disclose personal information on a first user stored in the personal information storage unit to a second user based on whether relationship information on a relationship between the first user and the second user satisfies a disclosure condition; and an information disclosure suggestion unit configured to generate suggestion display information for suggesting that the first user disclose the personal information on the first user to the second user, if the determiner has determined that the relationship information satisfies the disclosure condition.

The communication support server according to the present disclosure may further include: a message content analysis unit configured to analyze a content of a message transmitted from a first terminal device used by the first user and/or a second terminal device used by the second user. The relationship information is determined in accordance with a result of analysis by the message content analysis unit.

The communication support server according to the present disclosure may further include: a message content analysis unit configured to analyze a content of a message transmitted from a first terminal device used by the first user and/or a second terminal device used by the second user. The message content analysis unit may calculate a degree of good feeling of the second user for the first user based on the content of the message analyzed, and the relationship information may be determined in accordance with the degree of good feeling.

In the communication support server according to the present disclosure, the disclosure condition determination unit may determine whether an item included in the personal information and common between the first user and the second user satisfies, as the relationship information, the disclosure condition based on a content of the item.

In the communication support server according to the present disclosure, the relationship information is determined by a length of a friendship between the first user and the second user.

In the communication support server according to the present disclosure, the personal information includes at least one of an age, an occupation, an income, a hobby, a sense of value, or a life plan of the user himself, or an age, an occupation, an income, a hobby, a sense of value, or a life plan of a partner to which the user wishes to disclose the personal information.

In order to achieve the objective, a communication support system according to the present disclosure is connectable to a first terminal device used by a first user and a second terminal device used by a second use via a network. The communication support system includes: a personal information storage unit configured to store personal information on a user; a disclosure condition determination unit configured to determine whether to disclose personal information on the first user stored in the personal information storage unit to the second user based on whether relationship information on a relationship between the first user and the second user satisfies a disclosure condition; and an information disclosure suggestion unit configured to display, on the terminal device, suggestion display information for suggesting that the first user disclose the personal information on the first user to the second user, if the disclosure condition determination unit has determined that the relationship information satisfies the disclosure condition.

In order to achieve the objective, a communication support method according to the present disclosure includes: determining whether to disclose personal information on a first user to a second user based on whether relationship information on a relationship between the first user and the second user satisfies a disclosure condition, using a disclosure condition determination unit; and generating suggestion display information for suggesting that the first user disclose the personal information on the first user to the second user, using an information disclosure suggestion unit, if the relationship information is determined to satisfy the disclosure condition in the determining.

In order to achieve the objective, a communication support program according to the present disclosure causes a computer to execute: determining whether to disclose personal information on a first user to a second user based on whether relationship information on a relationship between the first user and the second user satisfies a disclosure condition; and generating suggestion display information for suggesting that the first user disclose the personal information on the first user to the second user, if the relationship information is determined to satisfy the disclosure condition in the determining.

### Advantages of the Invention

The communication support server, communication support system, communication support method, and communication support program according to the present disclosure using the means described above suggest that a user discloses undisclosed personal information in accordance with relationship information on between the user and another user to set the range of disclosing the personal information without any troublesome settings.

### BRIEF DESCRIPTION OF THE DRAWINGS

FIG. 1 is a system configuration diagram showing a communication support system according to an embodiment of the present disclosure.

FIG. 2 is a schematic diagram of a screen for setting personal information to be disclosed to another user by a user A.

FIG. 3 is a schematic diagram of an image showing a personal information page of the user A as viewed from the other user.

FIG. 4 is a schematic diagram showing a screen of a terminal device of the user A during the chat with the user B.

FIG. 5 is a schematic diagram showing a disclosure asking page displayed on the screen of the terminal device of the user A during a chat.

FIG. 6 is a schematic diagram of an image showing a personal information page of the user A as viewed from the user B.

FIG. 7 is a flowchart showing a work routine of the user A at the time of registration and the setting of the range of disclosing personal information according to the embodiment of the present disclosure.

FIG. 8 is a flowchart showing a work routine for setting the disclosure of the personal information, which is undisclosed to a user A, to the user B in accordance with the information on the relationship between the users A and B.

FIG. 9 is a schematic block diagram showing a configuration of a computer according to the embodiment of the present disclosure.

### DESCRIPTION OF EMBODIMENT

An embodiment of the present disclosure will now be described with reference to the drawings.

<Configuration>

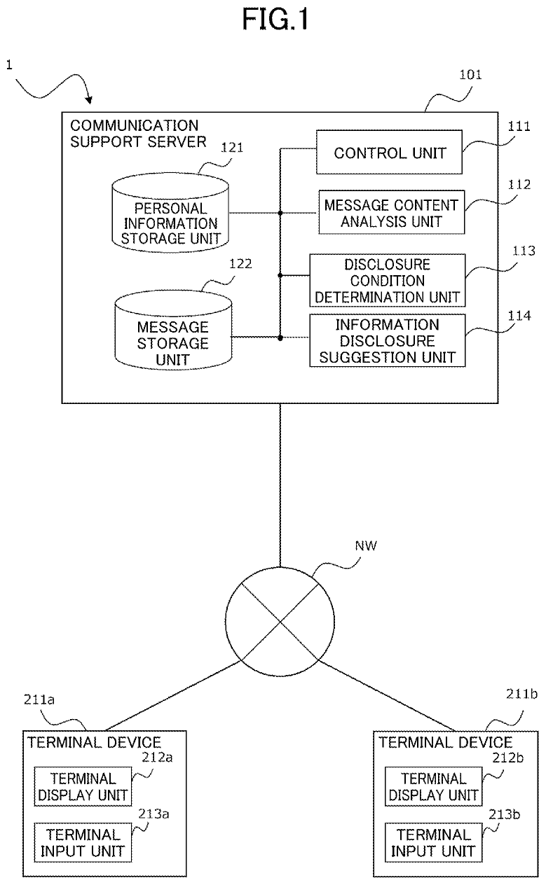

FIG. 1 is a system configuration diagram showing a communication support system 1 including a communication support server 101 according to an embodiment of the present disclosure. The communication support system 1 is for supporting users registered in a community, which is operated by a service provider (hereinafter, referred to as a “provider”), in matching each other, and supports the users who have become friends as a result of the matching in establishing communications. Specifically, the service proposes matching candidates among a plurality of users who have registered their requirements for a partner to be matched and their personal information, and becomes friends after submitting and accepting friend requests. Users who have become friends communicate with each other via chats. The communication support system 1 aims to establish smooth communications by assisting the users to disclose the personal information on the users using the relationship information according to the relationship between the users. The relationship information according to the embodiment of the present disclosure includes parameters defined by the contents of chats between users, exchanges other than the chats, degrees of good feeling, and other factors.

The users of the service register their personal information at the time of service registration. The personal information on each user includes the items, such as the information on the username (or nickname), age, occupation, income, hobbies, sense of values, and life plan, which are input as the user's own profile at the time of registration, and the items such as the age, occupation, income, hobbies, sense of values, and life plan, which are required for a matching partner. Further, the personal information on each user may include characteristic information indicating the characters according to the contents of the messages in the past chats in the communication support system 1.

As shown in FIG. 1, the communication support system 1 according to this embodiment is configured by connecting terminal devices 211 (e.g., terminal devices 211a and 211b) of the users and the communication support server 101 of the provider via a network NW such as the Internet or a virtual private network (VPN). For the sake of simplicity, FIG. 1 shows only the terminal device 211a (i.e., a first terminal device) and the terminal device 211b (i.e., a second terminal device) assuming two users. The communication support server 101 may be however connected to three or more users via the network NW.

The communication support server 101 includes a control unit 111, a message content analysis unit 112, a disclosure condition determination unit 113, a information disclosure suggestion unit 114, a personal information storage unit 121, and a message storage unit 122.

The control unit 111 controls exchanges of information among the terminal devices 211a and 211b and the communication support server 101. In addition, the control unit 111 controls disclosure and nondisclosure of personal information.

The message content analysis unit 112 functions to analyze the contents of the messages input by a user A (or a first user) or a user B (or a second user). The message content analysis unit 112 analyzes the contents of the messages based on the flows of the message exchanges. For example, the message content analysis unit 112 analyzes the contents of one or more message exchanges, recognize keywords related to personal information, and transmit the information to the disclosure condition determination unit 113. The message content analysis unit 112 makes the analysis based on the information such as the length of each message, the number of messages once each chat starts, and the duration of each message exchange. The analysis may be made in comparison with the other users. For example, the interchanges between the users A and B may be compared to those between the user A and another user (i.e., other than the user B) or between other users to analyze whether the flow is positive or negative. The message content analysis unit 112 analyzes the contents of the messages, and sets relationship information between users based on the message exchanges. The relationship information is a parameter indicating the relationship in which information is to be or not to be disclosed, and is stored in association with personal information stored in the personal information storage unit 121, which will be described later, for each user who has a history of interaction with the user. The relationship information may be set for each item, which will be described later. In addition, the message content analysis unit 112 may analyze the contents of the messages to calculate the user A's degree of good feeling for the user B and the user B's degree of good feeling for the user A. For example, if positive conversations are found in the past message exchanges between the users A and B, the degrees of good feeling are added, whereby higher degrees of good feeling are calculated. On the other hand, if negative conversations are found, the degrees of good feeling are subtracted, whereby lower degrees of good feeling are calculated. The information on the user A's degree of good feeling for the user B calculated by the message content analysis unit 112 is transmitted through the control unit 111 to the terminal device 211b of the user B. On the other hand, the information on the user B's degree of good feeling for the user A calculated by the message content analysis unit 112 is transmitted through the control unit 111 to the terminal device 211a of the user A. The message content analysis unit 112 may set the relationship information in accordance with the calculated degree of good feeling. The message content analysis unit 112 may analyze messages through machine learning trained using, as training data, past message exchanges.

The disclosure condition determination unit 113 functions to determine whether a condition (i.e., a disclosure condition) for one user to disclose his/her personal information to another user is satisfied in accordance with the relationship information between the users. The disclosure condition is a parameter stored in association with the personal information. The disclosure condition determination unit 113 determines whether the relationship information between the users on each item included in the personal information satisfies the disclosure condition.

The information disclosure suggestion unit 114 functions to suggest that the user discloses, to other users, each item of the personal information satisfying the disclosure condition as determined by the disclosure condition determination unit 113. For example, assume that an item of the undisclosed personal information on the user A satisfies the disclosure condition. In this case, the information disclosure suggestion unit 114 generates suggestion display information as a pop-up display of a page (e.g., a dialog box) for asking whether to disclose the item to the user B who is currently interacting with a terminal display unit 212a of the terminal device 211a of the user A. Upon receipt of the suggestion display information, the terminal device 211a causes a pop-up display of a page (e.g., a dialog box) for asking whether to disclose the information item.

The personal information storage unit 121 stores the personal information on the users registered in the service. Each item included in the personal information is stored in association with one or more disclosure conditions. The personal information storage unit 121 further stores the users' degrees of good feeling for other users. For example, the personal information storage unit 121 stores the user A's degree of good feeling for the user B and the user B's degree of good feeling for the user A in association with their personal information.

The message storage unit 122 stores the contents of messages in chats between users.

The terminal devices 211 (e.g., the terminal devices 211a and 211b) are terminal devices such as PCs, smartphones, tablet PCs, and cellular phones, and are terminals capable of displaying at least web information. The terminal devices 211 (e.g., the terminal devices 211a and 211b) may access the communication support server 101 using dedicated application software installed therein. The terminal devices 211 may access the communication support server 101 under an operating environment (e.g., an application programming interface (API) or a platform) provided by the communication support server 101.

Each terminal display unit 212 (e.g., the terminal display unit 212a or 212b) is a display unit such as a liquid crystal display or an organic EL display of a smartphone. Alternatively, each terminal display unit 212 may be a display device independent from the associated one of the terminal devices 211. Each terminal display unit 212 displays the messages transmitted from the communication support server 101 or the information on degree of good feeling.

Each terminal input unit 213 (e.g., a terminal input unit 213a or 213b) is, for example, an input device such as a touch panel integral with the associated one of the terminal display units 212 (e.g., the terminal display units 212a and 212b) such as the liquid crystal displays or the organic EL displays of the smartphones. Alternatively, each terminal input unit 213 may be a keyboard independent from the associated one of the terminal display units 212 (e.g., the terminal display units 212a and 212b) or from the associated one of the terminal devices 211. Further alternatively, each terminal input unit 213 may be an audio input device.

<Terminal Device Screen>

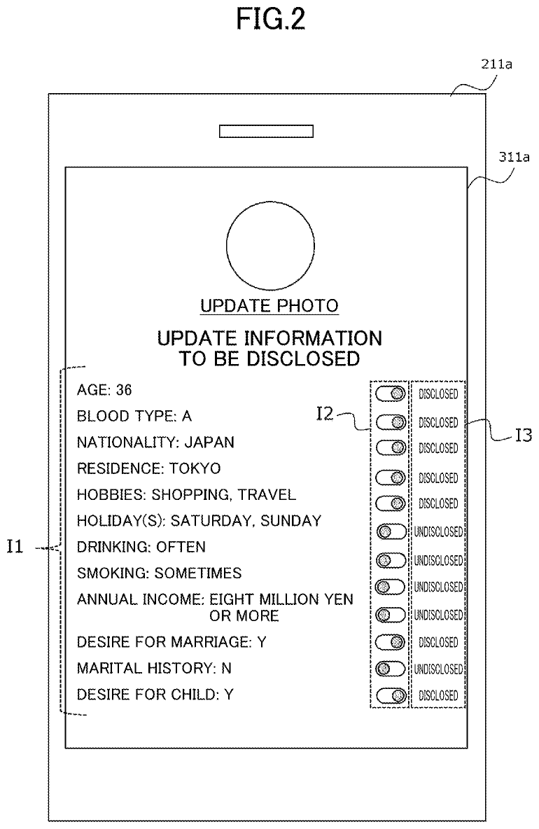

Now, display screens that may be displayed on the terminal devices 211 according to the embodiment of the present disclosure will be described with reference to FIGS. 2 to 5. The user A, Kenta uses the terminal device 211a, and the user B, Aya uses the terminal device 211b.

FIG. 2 is a schematic diagram of a screen for setting personal information to be disclosed to other users by a user A. After the user A, Kenta has taken a series of registration steps, the communication support server 101 transmits the personal information management page shown in FIG. 2 to the terminal device 211a. The user A then sets the disclosure of the personal information on a personal information management page 311a displayed on the terminal display unit 212a. Specifically, items I1 of the personal information are found on the left of the screen of the terminal device 211a. Found on the right of the screen are setting buttons I2 for setting whether to disclose the items, and character strings I3 indicating the disclosure statuses. The user operates the setting buttons I2 to select whether to disclosure the items I1. The character strings I3 are switched between “DISCLOSED” and “UNDISCLOSED” in accordance with the selection. In FIG. 2, the items “HOLIDAY(S)”, “DRINKING”, “SMOKING”, “ANNUAL INCOME”, and “MARITAL STATUS” out of the personal information on Kenta are set to be undisclosed, and the other items are set to be disclosed.

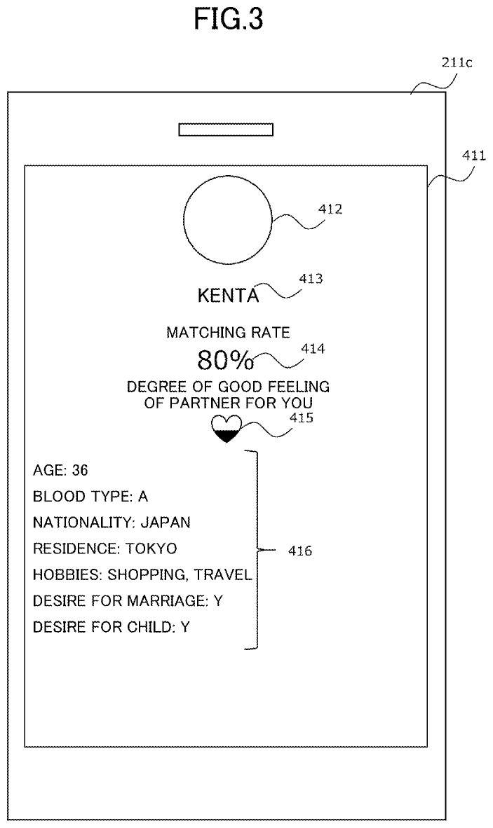

FIG. 3 is a schematic diagram of an image showing a personal information page of the user A as viewed from another user. As shown in FIG. 3, visible on a personal information page 411 of Kenta displayed on a terminal device 211c of the other user are: a photograph 412 and the name 413 of Kenta; and the matching degree 414 (80% in this embodiment) between the other user and Kenta, and a gauge 415 indicating a degree of good feeling. Only the items set to be disclosed on the personal information management page 311a by the user A are displayed as personal information 416.

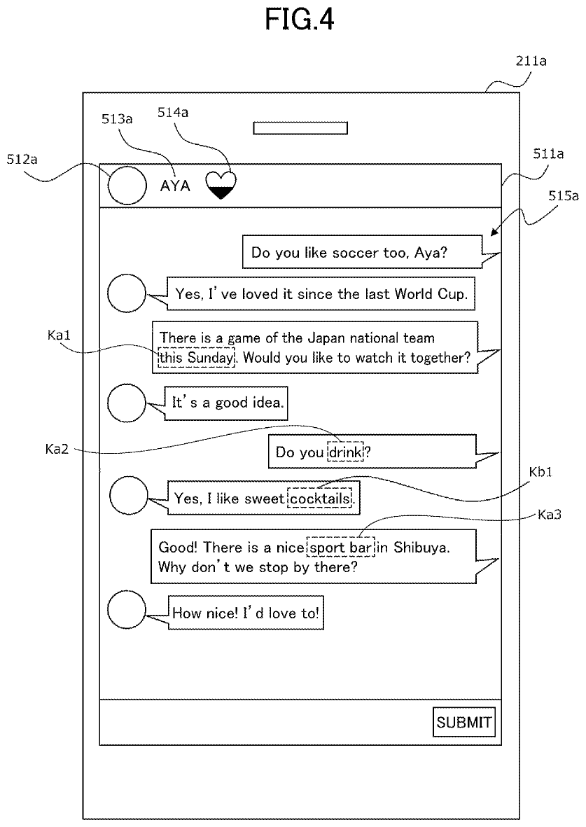

FIG. 4 is a schematic diagram showing a screen of the terminal device 211a of the user A, Kenta during a chat with the user B, Aya. Displayed on the screen of a terminal device 211a of Kenta is a chat page 511a which includes, on the upper left, a photograph 512a and the name 513a of the user B, Aya who is the chatting partner, and an gauge 514a indicating the degree of good feeling of Aya for Kenta. According to the gauge 514a indicating the degree of good feeling, a higher level of the gauge means a higher degree of good feeling. As shown in the figure, Kenta and Aya had a chat on their hobbies to some extent. The message content analysis unit 112 analyzes keywords, for example, related to the personal information based on the contents 515a in the flow of the chat. For example, the message content analysis unit 112 recognizes the keywords “this Sunday” Ka1, “drink” Ka2, and “sport bar” Ka3 uttered by Kenta. Similarly, the message content analysis unit 112 recognizes the keyword “cocktail” Kb1 in a message of Aya. The message content analysis unit 112 analyzes that the keyword “this Sunday” Ka1 represents “HOLIDAY(S)”, which is one of the items of the information on “Kenta”, and sets the relationship information with respect to the item “HOLIDAY(S)” using a flag indicating that the item is to be disclosed to Aya. Similarly, the message content analysis unit 112 analyzes that the keywords “drink” Ka2 and “sport bar” Ka3 represent “DRINKING” which is one of the items of the information on Kenta. The message content analysis unit 112 then analyzes that the keyword “cocktail” Kb1 represents “DRINKING” which is the one of the items of the information on Aya. The message content analysis unit 112 sets the relationship information with respect to the item “DRINKING” using a flag indicating that the information is to be disclosed to Aya. Similarly, the message content analysis unit 112 sets the relationship information with respect to the “DRINKING”, which is one of the items of the information on Aya using a flag indicating that the item is to be disclosed to Kenta.

Next, the disclosure condition determination unit 113 compares the relationship information with the disclosure condition to determine whether to disclose information. The disclosure condition determination unit 113 determines that the relationship information with respect to “HOLIDAY(S)”, which is one of the items of the information on Kenta, for Aya satisfies the disclosure condition. Similarly, the disclosure condition determination unit 113 determines that the relationship information with respect to “DRINKING”, which is one of the items of the information on Aya and Kenta, with each other satisfies the disclosure condition. The disclosure condition determination unit 113 then transmits, to the information disclosure suggestion unit, information indicating the fact that “HOLIDAY(S)” and “DRINKING”, which are the items of the information on Kenta, satisfy the disclosure condition of disclosing the items to Aya. Similarly, the disclosure condition determination unit 113 transmits, to the information disclosure suggestion unit, information indicating the fact that “DRINKING”, which is one of the items of the information on Aya, satisfies the disclosure condition of disclosing the item to Kenta.

Note that the message content analysis unit 112 may set the relationship information based on only a single keyword as described above, or may increase the value of the relationship information when a keyword related to the item is repeatedly uttered. For example, when there are a plurality of keywords related to “DRINKING” in the flow of a chat, the users A and B increase the parameter of the relationship information with respect to the item “DRINKING”. The disclosure condition determination unit 113 may determine whether the sum or the integrated value of the parameters of the relationship information with respect to “DRINKING” satisfies a predetermined value (i.e., a disclosure condition), and determine that the disclosure condition for disclosing the item “DRINKING” is satisfied when the sum or the integrated value is determined to satisfy the predetermined value.

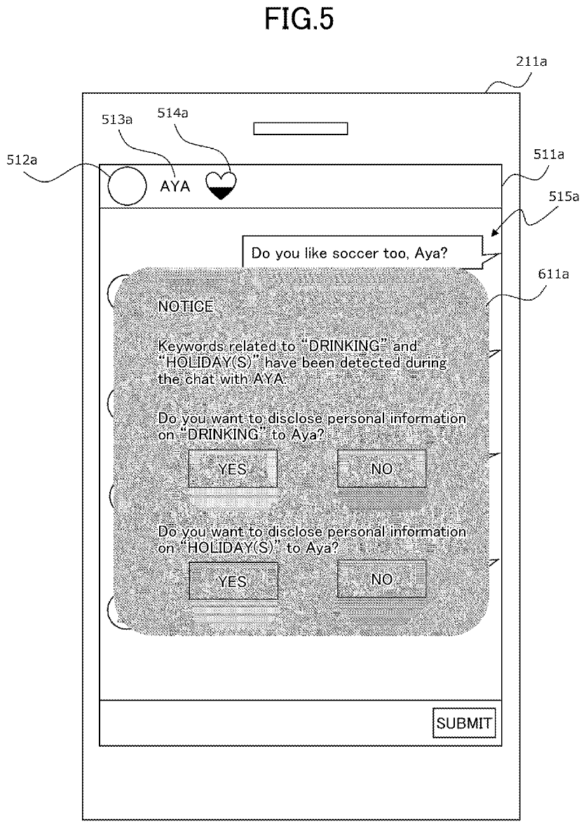

FIG. 5 is a schematic diagram showing a disclosure asking page displayed on the screen of the terminal device 211a of the user A, Kenta during a chat. As shown in the figure, the information disclosure suggestion unit 114 displays, as a pop-up message, a disclosure asking page (or dialog box) 611a on the screen of the terminal device 211a to suggest that Kenta disclose, to Aya, the items “DRINKING” and “HOLIDAY(S)” of the information on Kenta determined to satisfy the disclosure condition by the disclosure condition determination unit 113. The disclosure asking page 611a displays that keywords related to “HOLIDAY(S)” and “DRINKING” have been detected during the chat with Aya. Displayed to Kenta on the disclosure asking page 611a are information and buttons for asking whether to disclose the items “HOLIDAY(S)” and “DRINKING”. Kenta presses the buttons to determine whether to disclosure the suggested items. The information disclosure suggestion unit 114 displays, as a pop-up message, the disclosure asking page on the terminal device 211b of not only Kenta but also of Aya.

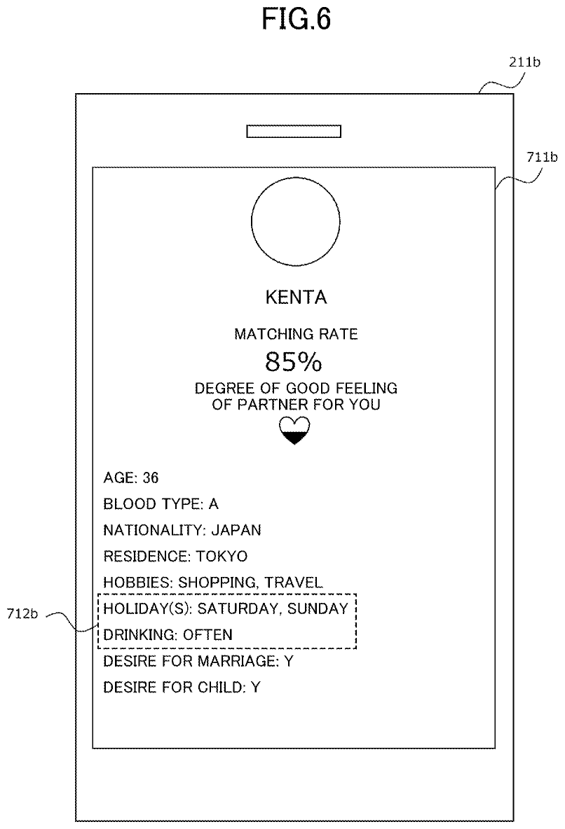

FIG. 6 is a schematic diagram of an image showing a personal information page of the user A, Kenta as viewed from the user B, Aya. Assume that the user A, Kenta selects the buttons to disclosing the items “HOLIDAY(S)” and “DRINKING” to the user B, Aya on the disclosure asking page 611a. In this case, as shown in FIG. 6, information 712b on “HOLIDAY(S)” and “DRINKING” are additionally disclosed on a personal information page 711b of “Kenta” viewed by Aya.

<Processing Flow>

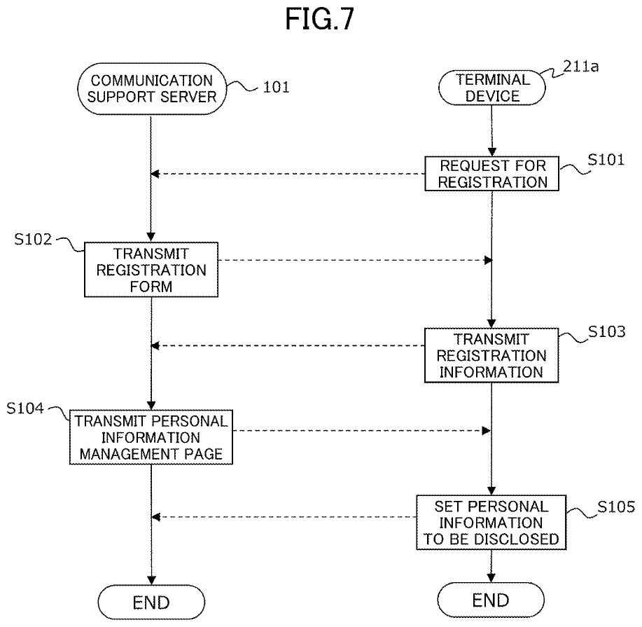

Now, a work routine at the registration of a user A will be described with reference to the flowchart shown in FIG. 7. First, in step S101, the user A accesses the communication support server 101 from the terminal device 211a and transmits information indicating a wish for registration.

Next, in step S102, the communication support server 101 then transmits, to the terminal device 211a, a registration form causing the user A to fill personal information.

In step S103, the user A transmits the registration information with his/her personal information to the communication support server 101.

Next, in step S104, the communication support server 101 transmits a personal information management page for setting the disclosure of the personal information on the user A to the terminal device 211a. In step S105, the user A sets whether to disclose the personal information on the received personal information management page and transmits the set page back to the communication support sever 101. In this manner, the registration procedure of the user A and the setting of the personal information to be disclosed to other users are completed.

In this embodiment, the communication support server 101 causes the user A to set the disclosure of the personal information via the personal information management page, but the setting is not limited thereto. For example, the personal information may be set on the registration form.

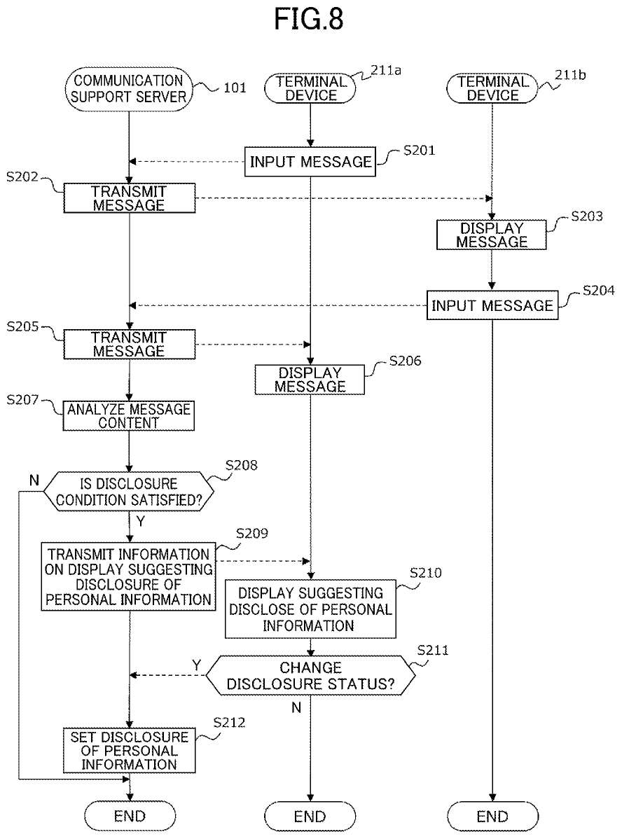

Now, a work routine for setting the disclosure of the personal information, which is undisclosed to user A, to the user B in accordance with the relationship information between the users A and B with reference to the flowchart shown in FIG. 8. First, the user A is using the terminal device 211a, and the user B is using the terminal device 211b. Both the users have signed up for the service and are ready to exchange messages with each other.

First, in step S201, the user A inputs a message to be transmitted to the user B from the terminal input unit 213a of the terminal device 211a. The terminal device 211a transmits the input message to the communication support server 101.

In step S202, the control unit 111 transmits, to the user B, the message transmitted in step S201. Specifically, the control unit 111 stores the message transmitted in step S201 in the message storage unit, and transmits the stored message to the terminal device 211b used by the user B.

In step S203, the terminal device 211b displays the message transmitted in step S202 on the terminal display unit 212b.

In step S204, the user B inputs a message to be transmitted to the user A through the terminal input unit 213b of the terminal device 211b. The terminal device 211b transmits the input message to the communication support server 101.

In step S205, the control unit 111 transmits the message transmitted in step S204 to the user A. Specifically, the control unit 111 stores the message transmitted in step S204 in the message storage unit 122, and transmits the stored message to the terminal device 211a of the user A.

In step S206, the terminal device 211a displays the message transmitted in step S205 on the terminal display unit 212a. Note that steps S201 to S206 may be repeated, or a message may be first transmitted from the user B to the user A to start a chat.

In step S207, the message content analysis unit 112 analyzes the contents of the messages exchanged in steps S201 and S206. The message content analysis unit 112 then sets the relationship information between the users A and B with respect to the items in accordance with the analysis result.

In step 208, the disclosure condition determination unit 113 determines whether the relationship information satisfies the disclosure condition. If the relationship information satisfies the disclosure condition (Y), the process proceeds to step S209. If the relationship information does not satisfy the disclosure condition (N), the process proceeds to END to end the routine.

In step S209, the information disclosure suggestion unit 114 generates disclosure suggestion display information that suggests that the user A disclose one or more item of the personal information, and transmits the disclosure suggestion display information to the terminal device 211a of the user A.

In step S210, based on the disclosure suggestion display information transmitted in step S209, a disclosure asking page (or dialog box) for asking whether to disclose one or more items of the personal information is displayed as a pop-up message on the terminal device 211a of the user A.

In step S211, the user A determines and inputs whether to disclose each item on the disclosure asking page. If the item is to be disclosed (Y), the process proceeds to step S212. If the item is not to be discloser (N), the process proceeds to END to end the routine.

In step S212, the control unit 111 sets to disclose, to the user B, the item determined in step S211 to be disclosed.

As described above, the communication support system 1 according to this embodiment suggests that a user disclose his/her personal information, which is undisclosed in accordance with the relationship information between the users, to the users in accordance with the contents of the information exchanges between the users to set whether to disclosure the personal information without any troublesome setting works.

In the embodiment described above, the disclosure condition determination unit 113 determines whether the disclosure condition of disclosing one or more items is satisfied based on the contents of the message exchange as the relationship information between users. The determination is however not limited thereto. For example, the disclosure condition determination unit 113 may determine that the disclosure condition of disclosing one or more specific items is satisfied based on the fact that the contents of the specific items are common between users, as the relationship information between the users. Specifically, none of the users A and B discloses the item “marital status”. If the “marital status” of each user is “unmarried”, the disclosure condition determination unit 113 may determine that the disclosure condition of disclosing the “marital status” which is one of the items of the information on the users A and B is satisfied. This allows the users know the sense of values common to each other earlier and deepen the relationship in a shorter time.

The disclosure condition determination unit 113 may determine whether the disclosure condition is satisfied in accordance with the degree of good feeling of each user, as the relationship information. For example, specifically, if the degree of good feeling of each user is high, the disclosure condition determination unit 113 may estimate that the users are reliable to each other and determine that the disclosure condition of disclosing the undisclosed item “annual income” is satisfied. The information disclosure according to the degree of good feeling in this manner allows the users to deepen the friendship between the users.

In the embodiment described above, the disclosure condition of disclosing the item of the personal information is a specific word or a keyword uttered in a chat between users. The disclosure condition is not limited thereto. For example, the length of the friendship between users may be set as the disclosure condition. Specifically, the disclosure condition determination unit 113 may determine that the disclosure condition of disclosing one or more items is satisfied, if the friendship between the users lasts in a predetermined period, as the relationship information. Accordingly, a deeper relationship over time is expected.

The disclosure condition of disclosing the item of the personal information may be determined based on a request for disclosure from another user. For example, the disclosure condition determination unit 113 may determine that the disclosure condition of disclosing a specific item is satisfied if at least one of the users matched according the relationship information requests the other user to disclose the item. This allows the users know the sense of values common to each other quickly and deepen the relationship earlier.

<Program>

Now, details of a program for fulfilling the functions constituting the communication support server 101 according to this embodiment will be described.

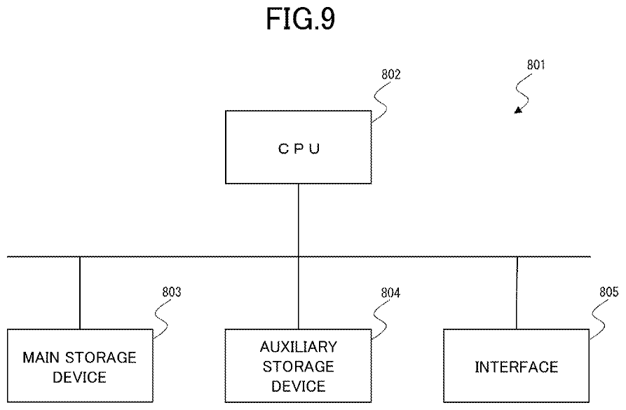

The communication support server 101 is mounted in a computer 801 shown in FIG. 9. The operations of the components of the communication support server 101 are stored in the form of a program in an auxiliary storage device 804. A CPU 802 reads the program from the auxiliary storage device 804, loads the program in a main storage device 803, and executes the processing described above in accordance with the program. In accordance with the program, the CPU 802 secures, in the main storage device 803, a storage area corresponding to the storage unit.

Specifically, the program causes a computer to execute: determining whether to disclose personal information on a first user to a second user based on whether relationship information on a relationship between the first user and the second user satisfies a disclosure condition; and generating suggestion display information for suggesting that the first user disclose the personal information on the first user to the second user, if the relationship information is determined to satisfy the disclosure condition in the determining.

Note that the auxiliary storage device 804 is an example of a non-transitory tangible medium. Other examples of the tangible, non-transitory medium include a magnetic disk, a magneto-optical disk, a CD-ROM, a DVD-ROM, and a semiconductor memory connected via an interface. If this program is distributed to a computer via a network, the computer distributed with the program may load the program in its main storage device to execute the processing described above.

The program may fulfill some of the functions described above. Further, the program may be a what is called a “difference file” (or “difference program”) that fulfills the functions described above in combination with another program already stored in the auxiliary storage device.

The embodiment described above may be implemented in other various forms. Various omissions, substitutions and changes may be made without departing from the spirit of the invention. The embodiment and variations thereof are included in the scope and spirit of the invention and also in the scope of the invention recited in the claims and equivalents thereof. The present disclosure is applicable to the occasion where support of communications is necessary between two or more people for a business negotiation, a BtoB transaction, recruiting activities, communications between a couple, and expansion of friendship.

### DESCRIPTION OF REFERENCE CHARACTERS

1 Communication Support System
101 Communication Support Server
111 Control Unit
112 Message Content Analysis Unit
113 Disclosure Condition Determination Unit
114 Information Disclosure Suggestion Unit
121 Personal Information Storage Unit
122 Message Storage Unit
211, 211a, 211b Terminal Device
212, 212a, 212b Terminal Display Unit
213, 213a, 213b Terminal Input Unit

1. A communication support server comprising:
a personal information storage unit configured to store personal information on a user;
a disclosure condition determination unit configured to determine whether to disclose personal information on a first user stored in the personal information storage unit to a second user based on whether relationship information on a relationship between the first user and the second user satisfies a disclosure condition; and
an information disclosure suggestion unit configured to generate suggestion display information for suggesting that the first user disclose the personal information on the first user to the second user, if the disclosure condition determination unit has determined that the relationship information satisfies the disclosure condition.

2. The communication support server of claim 1, further comprising:
a message content analysis unit configured to analyze a content of a message transmitted from a first terminal device used by the first user and/or a second terminal device used by the second user, wherein
the relationship information is determined in accordance with a result of analysis by the message content analysis unit.

3. The communication support server of claim 1, further comprising:
a message content analysis unit configured to analyze a content of a message transmitted from a first terminal device used by the first user and/or a second terminal device used by the second user, wherein
the message content analysis unit calculates a degree of good feeling of the first user for the second user based on the content of the message analyzed, and the relationship information is determined in accordance with the degree of good feeling.

4. The communication support server of claim 1, wherein
the disclosure condition determination unit determines whether an item included in the personal information and common between the first user and the second user satisfies, as the relationship information, the disclosure condition based on a content of the item.

5. The communication support server of claim 1, wherein
the relationship information is determined by a length of a friendship between the first user and the second user.

6. The communication support server of claim 1, wherein
the personal information includes at least one of an age, an occupation, an income, a hobby, a sense of value, or a life plan of the user, or an age, an occupation, an income, a hobby, a sense of value, or a life plan of a partner to which the user wishes to disclose the personal information.

7. A communication support system connectable to a first terminal device used by a first user and a second terminal device used by a second user via a network, the communication support system comprising:
a personal information storage unit configured to store personal information on a user;
a disclosure condition determination unit configured to determine whether to disclose personal information on the first user stored in the personal information storage unit to the second user based on whether relationship information on a relationship between the first user and the second user satisfies a disclosure condition; and
an information disclosure suggestion unit configured to display, on the first terminal device, suggestion display information for suggesting that the first user disclose the personal information on the first user to the second user, if the disclosure condition determination unit has determined that the relationship information satisfies the disclosure condition.

8. A communication support method comprising:
determining whether to disclose personal information on a first user to a second user based on whether relationship information on a relationship between the first user and the second user satisfies a disclosure condition, using a disclosure condition determination unit; and
generating suggestion display information for suggesting that the first user disclose the personal information on the first user to the second user, using an information disclosure suggestion unit, if the relationship information is determined to satisfy the disclosure condition in the determining.

9. A communication support program for causing a computer to execute:
determining whether to disclose personal information on a first user to a second user based on whether relationship information on a relationship between the first user and the second user satisfies a disclosure condition; and
generating suggestion display information for suggesting that the first user disclose the personal information on the first user to the second user, if the relationship information is determined to satisfy the disclosure condition in the determining.

10. The communication support server of claim 2, wherein
the personal information includes at least one of an age, an occupation, an income, a hobby, a sense of value, or a life plan of the user, or an age, an occupation, an income, a hobby, a sense of value, or a life plan of a partner to which the user wishes to disclose the personal information.

11. The communication support server of claim 3, wherein
the personal information includes at least one of an age, an occupation, an income, a hobby, a sense of value, or a life plan of the user, or an age, an occupation, an income, a hobby, a sense of value, or a life plan of a partner to which the user wishes to disclose the personal information.

12. The communication support server of claim 4, wherein
the personal information includes at least one of an age, an occupation, an income, a hobby, a sense of value, or a life plan of the user, or an age, an occupation, an income, a hobby, a sense of value, or a life plan of a partner to which the user wishes to disclose the personal information.

13. The communication support server of claim 5, wherein
the personal information includes at least one of an age, an occupation, an income, a hobby, a sense of value, or a life plan of the user, or an age, an occupation, an income, a hobby, a sense of value, or a life plan of a partner to which the user wishes to disclose the personal information.
